(19) United States
(12) Patent Application Publication
(10) Pub. No.: US 2015/0373026 A1
(43) Pub. Date: Dec. 24, 2015

(54) PERMISSION MANAGEMENT METHOD, DEVICE AND SYSTEM FOR CLOUD PLATFORM SERVICE

(71) Applicant: TENCENT TECHNOLOGY (SHENZHEN) COMPANY LIMITED, Shenzhen, Guangdong (CN)

(72) Inventor: Dongshan Xu, Shenzhen, Guangdong (CN)

(73) Assignee: TENCENT TECHNOLOGY (SHENZHEN) COMPANY LIMITED, Shenzhen, Guangdong (CN)

(21) Appl. No.: 14/319,578

(22) PCT Filed: Dec. 17, 2013
(86) PCT No.: PCT/CN2013/089724

§ 371 Date: Jun. 30, 2014

(30) Foreign Application Priority Data
Mar. 14, 2013 (CN) 201310081876.9

(51) Int. Cl. H04L 29/06; H04L 29/08

(52) U.S. Cl. CPC H04L 63/102; H04L 63/083; H04L 67/141

(57) ABSTRACT

A permission management method, a permission management device, and a permission management system for a cloud platform service are disclosed. The method includes: obtaining an operation/access request of a calling party, wherein the operation/access request includes operation information, target information and session information of the calling party, and the target information of the calling party includes an ongoing session information; determining that the session information includes an initial session information of the calling party and the initial session information is valid; and conducting an permission check for the operation/access request. Thus, the legitimacy of an operation/access request for a cloud platform service can be ensured, and the security of a cloud platform service can be guaranteed.

### CROSS REFERENCE TO RELATED APPLICATIONS

The present application is a continuation application of PCT Patent Application No. PCT/CN2013/089724, filed on Dec. 17, 2013, which claims the benefit of priority to China patent application NO. 201310081876.9 filed in the Chinese Patent Office on Mar. 14, 2013 and entitled “PERMISSION MANAGEMENT METHOD, DEVICE AND SYSTEM FOR CLOUD PLATFORM SERVICE”, the content of which is hereby incorporated by reference in its entirety.

### FIELD OF THE TECHNICAL

The disclosure relates to the field of internet technology, and particularly to a permission management method, a permission management device, and a permission management system for a cloud platform service.

### BACKGROUND

The section provides background information related to the present disclosure which is not necessarily prior art.

A cloud platform (cloud computing) is a kind of internet service model which is paid for on the basis of usage amount. Such a model offers available, convenient, and on-demand network access to a shared pool of configurable computing resources, the resources including networks, servers, storages, application software, and services. These resources can be offered quickly with only a little necessary management work or a little necessary interaction with service providers. In conventional cloud platform services, account management and access control are mostly performed by managing and controlling direct service calling parties rather than initiators who triggers the direct service calling party. A few systems consider the discrimination of initiators, but the initiators are only discriminated in the manner that the direct service calling parties appoint the initiators without further confirmation whether the initiators are legitimate.

Since only direct calling parties are authenticated in most of the conventional account management and access control modes, when facing complex environments of cloud platform, it is very possible that a plurality of cloud platform services and components may operate on illegitimate destination resources due to that a security vulnerability of one weak system is exploited, finally enabling some illegitimate initiators to use the cloud platform service and components to operate on resources that does not belong to them. As a result, sensitive resources in the cloud platform may be unauthorizedly altered or leaked, and benefits and reputations of the cloud platform or the related third service providers may be hurt.

### SUMMARY

Exemplary embodiments of the present invention provide a permission management method, a permission management device, and a permission management system for a cloud platform service, in which the legitimacy of operations and accesses for the cloud platform service can be ensured, and the security of the cloud platform service can be guaranteed.

One embodiment of the present invention provides a permission management method, comprising: obtaining, by a target cloud platform service, an operation/access request of a calling party, wherein the operation/access request includes operation information, target information and session information of the calling party, and the target information of the calling party includes an ongoing session information;

determining, by the target cloud platform service, that the session information includes an initial session information of the calling party and the initial session information is effective; and conducting, by the target cloud platform service, an permission check for the operation/access request, wherein the permission check comprises: determining whether the session information is legitimate; obtaining permission information of the calling party and an initial user according to the ongoing session information and the initial session information, respectively; determining whether the operation information of the operation/access request is legitimate according to the permission information of the calling party; and determining whether the target information of the operation/access request is legitimate according to the permission information of the initial user.

Another embodiment of the present invention provides an permission management device for a cloud platform service, comprising: an operation/access obtaining module configured to obtain an operation/access request of a calling party, wherein the operation/access request includes operation information, target information and session information of the calling party, and the target information of the calling party includes this ongoing session information; a session judgment module configured to confirm that the session information includes an initial session information of the calling party and the initial session information is effective; an permission check module configured to conduct an permission check for the operation/access request, wherein if the session judgment module confirms that the session information includes the initial session information of the calling party and the initial session information is effective, the permission check comprises: determining whether the session information is legitimate; obtaining permission information of the calling party and an initial user according to the ongoing session information and the initial session information, respectively; determining whether the operation information of the operation/access request is legitimate according to the permission information of the calling party; and determining whether the target information of the operation/access request is legitimate according to the permission information of the initial user.

Yet another embodiment of the present invention provides a calling device for a cloud platform service, comprising: an permission check obtaining module configured to obtain an indirect service authentication request from a target cloud platform service, wherein the indirect service authentication request includes an operation/access request of a calling party and session information of the calling party, and the session information of the calling party includes an ongoing session information of the calling party and an initial session information; an indirect service authentication module configured to conduct an permission check for the operation/access request of the calling party and the session information of the calling party; and an permission check returning module configured to return result of the permission check to the target cloud platform service; wherein the permission check comprises: determining whether the session information is legitimate; obtaining permission information of the calling party and an initial user according to the ongoing session information and the initial session information, respectively; determining whether the operation information of the operation/access request is legitimate according to the permission information of the calling party; determining whether the target information of the operation/access request is legitimate according to the permission information of the initial user.

Yet another embodiment of the present invention provides an permission management system for a cloud platform service, which includes the mentioned above permission management device for a cloud platform service and calling device for a cloud platform service, wherein, the calling device for the cloud platform service is configured to send an operation/access request to the target cloud platform service, the operation/access request includes operation information, target information and session information of the calling party, and the session information of the calling party includes an ongoing session information;

the permission management device for the cloud platform service is configured to: obtain the operation/access request sent by the calling device for a cloud platform service; confirm that the session information includes an initial session information of the calling party and the initial session information is effective; and conduct an permission check for the operation/access request, wherein the permission check comprises: determining whether the session information is legitimate, obtaining the permission information of the calling party and the initial user according to the ongoing session information and the initial session information; determining whether the operation information of the operation/access request is legitimate according to the permission information of the calling party; and determining whether the operation/access request is legitimate according to the permission information of the initial user.

In various embodiments of the present invention, when an operation/access request is sent to indirectly call resources of the target cloud platform service, the initial session information of the calling party is carried in the operation/access request. Therefore, the target cloud platform service can check for two parties, i.e. the direct calling party and the initial user, so as to ensure that the operation/access request is within a legitimate range and guarantee the overall security of the cloud platform service and the third resource in complex environments of cloud platform.

### BRIEF DESCRIPTION OF THE DRAWINGS

In order to illustrate the embodiments or existing technical solutions more clearly, a brief description of drawings that assist the description of embodiments of the invention or existing art will be provided below. It would be apparent that the drawings in the following description are only for some of the embodiments of the invention. A person having ordinary skills in the art will be able to obtain other drawings on the basis of these drawings without paying any creative work.

FIG. 1 is a flowchart of a permission management method for a cloud platform service according to one embodiment of the present invention;

FIG. 2 is a flowchart of a permission management method for a cloud platform service according to another embodiment of the present invention;

FIG. 3 is a flowchart of a permission management method for a cloud platform service according to yet another embodiment of the present invention;

FIG. 4 is a flowchart of a permission management method for a cloud platform service according to yet another embodiment of the present invention;

FIG. 5 is a structural diagram of a permission management device for a cloud platform service according to yet another embodiment of the present invention;

FIG. 6 is a structural diagram of a calling device for a cloud platform service according to yet another embodiment of the present invention;

FIG. 7 is a structural diagram of an account authentication system for a cloud platform service according to yet another embodiment of the present invention;

FIG. 8 is a structural diagram of a permission management system for a cloud platform service according to yet another embodiment of the present invention;

FIG. 9 depicts an exemplary environment incorporating certain disclosed embodiments;

FIG. 10 depicts an exemplary computing system consistent with the disclosed embodiments.

### DETAILED DESCRIPTION OF ILLUSTRATED EMBODIMENTS

The present invention is herein after described further in detail with reference to the accompanying drawings so as to make the objective, technical solution, and merits of exemplary embodiments more apparent. The term “exemplary” used throughout this description means “serving as an example, instance, or illustration,” and should not necessarily be construed as preferred or advantageous over other exemplary embodiments. It would be apparent that a person having ordinary skills in the art may obtain other embodiments based on the illustrated exemplary embodiments of the invention without paying any creative work, and these embodiments should also be within the protection scope sought by the present invention.

FIG. 9 depicts an exemplary environment 600 incorporating exemplary permission management methods and systems for a cloud platform service in accordance with various disclosed embodiments. As shown in FIG. 9, the environment 600 can include a server 604, a terminal 606, and a communication network 602. The server 604 and the terminal 606 may be coupled through the communication network 602 for information exchange including sending/receiving information such as session information, an access/operation request, an operation result, etc. Although only one terminal 606 and one server 604 are shown in the environment 600, any number of terminals 606 or servers 604 may be included, and other devices may also be included.

The communication network 602 may include any appropriate type of communication network for providing network connections to the server 604 and terminal 606 or among multiple servers 604 or terminals 606. For example, the communication network 602 may include the Internet or other types of computer networks or telecommunication networks, either wired or wireless.

A terminal, as used herein, may refer to any appropriate user terminal with certain computing capabilities, e.g., a personal computer (PC), a work station computer, a hand-held computing device (e.g., a tablet), a mobile terminal (e.g., a mobile phone or a smart phone), or any other client-side computing device.

A server, as used herein, may refer to one or more server computers configured to provide certain server functionalities, e.g., obtaining an operation/access request, conducting a permission check, etc. A server may also include one or more processors to execute computer programs in parallel.

The server 604 and the terminal 606 may be implemented on any appropriate computing platform.

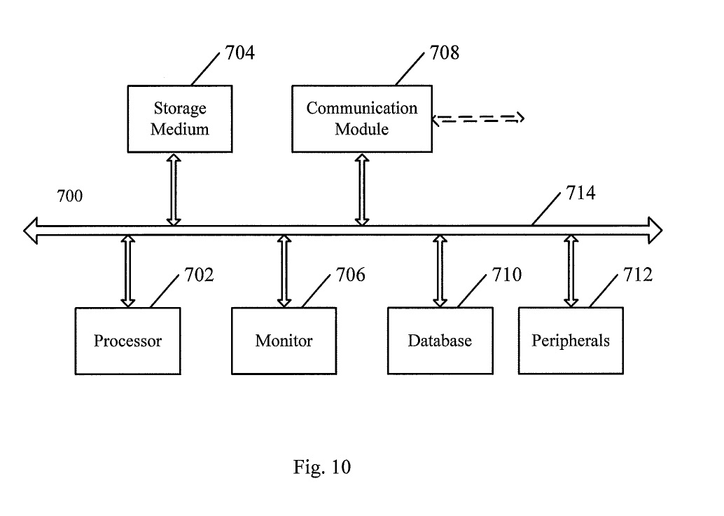

FIG. 10 shows a block diagram of an exemplary computing system 700 (or computer system 700) capable of implementing the server 604 and/or the terminal 606. As shown in FIG. 10, the exemplary computer system 700 may include a processor 702, a storage medium 704, a monitor 706, a communication module 708, a database 710, peripherals 712, and one or more bus 714 to couple the devices together. Certain devices may be omitted and other devices may be included.

The processor 702 can include any appropriate processor or processors. Further, the processor 702 can include multiple cores for multi-thread or parallel processing. The storage medium 704 may include memory modules, e.g., Read-Only Memory (ROM), Random Access Memory (RAM), and flash memory modules, and mass storages, e.g., CD-ROM, U-disk, removable hard disk, etc. The storage medium 704 may store computer programs for implementing various processes (e.g., obtaining an operation/access request, conducting a permission check for the request, etc.), when executed by the processor 702.

The monitor 706 may include display devices for displaying contents in the computing system 700, e.g., displaying check results and operation results. The peripherals 712 may include I/O devices such as keyboard and mouse.

Further, the communication module 708 may include network devices for establishing connections through the communication network 602. The database 710 may include one or more databases for storing certain data and for performing certain operations on the stored data, e.g., storing session information, operation results, and corresponding relationship(s) there between, or any other suitable data searching and management operations.

In operation, the terminal 606 may cause the server 604 to perform certain actions, e.g., obtaining the operation/access request, conducting a permission check for the request, etc. The server 604 may be configured to provide structures and functions for such actions and operations. More particularly, the server 604 may include a permission management server or any other suitable servers for corresponding functions.

In various embodiments, a terminal involved in the disclosed methods and systems can include the terminal 606, while a server involved in the disclosed methods and systems can include the server 604. The methods and systems disclosed in accordance with various embodiments can be executed by a computer system. In one embodiment, the disclosed methods and systems can be implemented by a server.

Various embodiments provide permission management methods, devices and systems for a cloud platform service. The methods, devices and systems are illustrated in various examples described herein.

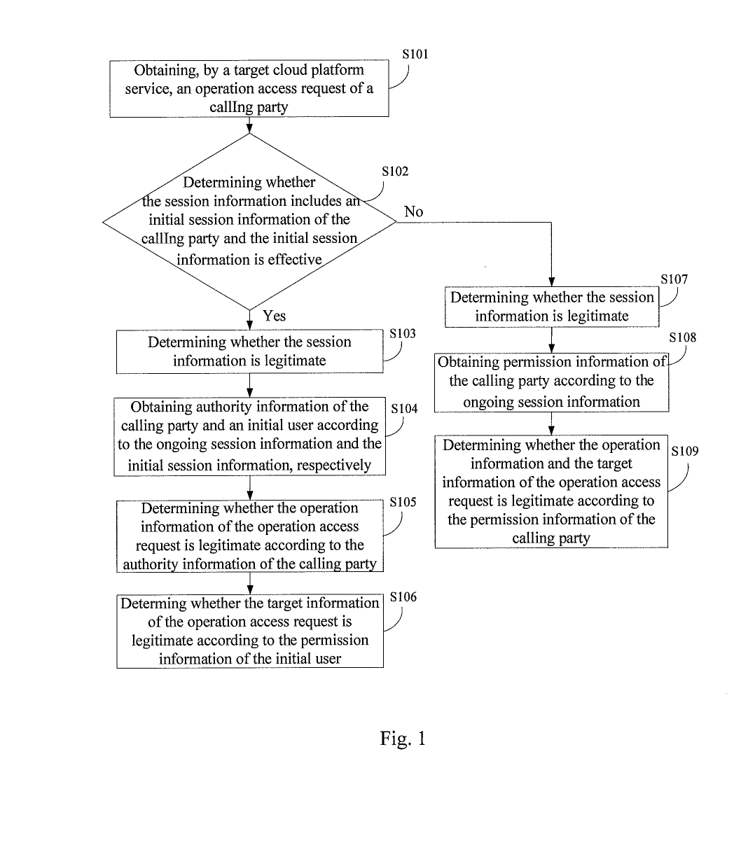

As shown in FIG. 1, it is a flowchart of a permission management for a cloud platform service according to one embodiment of the present invention. The method of the present embodiment may be implemented in the target cloud platform service, namely, it may be implemented in the called cloud platform service. As shown in the figure, the method of the present embodiment may comprise steps S101-S109.

Step S101 is: obtaining, by a target cloud platform service, an operation/access request of a calling party, wherein the operation/access request includes operation information, target information and session information of the calling party, and the target information of the calling party includes ongoing session information. Specifically, the calling party in the embodiment may be a direct user of the cloud platform service. Alternatively, the calling party may be another cloud platform service that calls the target cloud platform service. In this case, the login account of the cloud platform service that acts as a calling party is a direct user of the target cloud platform service, and the user of the cloud platform service that acts as the calling party is referred to as an initial user. If the calling party is a direct user, the direct user is just the initial user. The operation information in the operation/access request may include an operation type. The target information in the operation/access request may include service information of the operation target (for example, appid, i.e. application identification, that the operation/access needs to call) and IP of an operation target (Internet Protocol, herein is the internet protocol address of the target of the operation/access). The session information of the calling party is the session information that the target cloud platform service returns to the calling party after the calling party successfully logs in the target cloud computing service beforehand. The session information is used for communication session between the calling party and the target cloud computing service after the calling party has logged in. The ongoing session information may include user information, a session identifier, a session source IP, a session destination IP, etc. of the calling party.

Step S102 is: determining, by the target cloud platform service, whether the session information includes initial session information of the calling party and the initial session information is effective. In this embodiment, if the session information of the calling party doesn't include the initial session information of the calling party or the initial session information is invalid, the calling party is a direct user. If the session information of the calling party includes the initial session information of the calling party, the calling party is an indirect user. The initial session information of the initial user is the session information obtained during the process that the initial user logs in the initial cloud platform service which the calling party belongs to. Similarly as the ongoing session information mentioned above, the initial session information of the initial user may also include the user information, the session identifier, the session source IP, the session destination IP, etc. of the initial user, and it is used for communication session between the initial user and the initial cloud platform service after the login is successful. Whether the initial session information is valid is determined by judging whether the session identifier of the initial session information is valid. For example, when being zero or null, the session identifier is invalid, and it can be further determined that the initial session information is invalid. Otherwise, it is valid. Or, it may be judged whether the initial session information is consistent with the ongoing session information of the calling party. If they are consistent, the initial session information can be determined invalid, and otherwise valid. If the session information includes the initial session information of the calling party and the initial session information is valid, the operation/access request sent by the calling party is an indirect call and the permission check process of step 103 to step 105 is performed. Otherwise, the permission check process of step 106 to step 107 is performed. It should be noted that both of the two kinds of permission check processes mentioned above may be performed in the target cloud platform service. Alternatively, the target cloud platform service may delivers the indirect service authentication request including the session information of the calling party and the operation/access request or the direct service authentication request to an account authentication system to perform the permission check process of step 103 to step 105 or the permission check process of step 106 to step 107, and then, the result of the permission check may be obtained by the target cloud platform service from the account authentication system.

Step S103 is: determining whether the session information is legitimate. In specific implementation, it is determined by judging whether the session information of the operation/access request is consistent with the session information established when the calling party logins the target cloud platform, if they are consistent, the session is confirmed legitimate, otherwise illegitimate. It should be noted that in other optional embodiments, step 103 or step 107 may be performed firstly, and then step 102 is performed, which will not affect the implementation of the present invention.

Step S104 is: obtaining permission information of the calling party and an initial user according to the ongoing session information and the initial session information, respectively. The permission information of the calling party and the permission information of the initial user may be an permission information list affirmed by the target cloud platform service for the ongoing login of the calling party. For example, the permission information of the calling party and the initial user may be obtained by the target cloud platform service from the account authentication system when the calling party logs in the target cloud platform service, and the content of the permission information may include permissions for the types of the operations corresponding to the calling party and the initial user, respectively, a plurality of operable target services (such as appid), the operating ranges of the operable target services (for example, the ranges may be expressed using IP), etc. If the target cloud platform service locally saves the session information of the calling party, the permission information of the calling party, and the permission information of the initial user, which are obtained from the account authentication system, the permission check may be locally conducted by the target cloud platform service. Otherwise, the permission check may be conducted by sending the operation/access request to the account authentication system.

Step S105 is: determining whether the operation information of the operation/access request is legitimate according to the permission information of the calling party. In the implementation, it may be determined by judging whether the operation information in the operation/access request is in the permission information list. If it is, the operation information is determined to be legitimate, for example, a legitimate operation type.

Step S106 is: determining whether the target information of the operation/access request is legitimate according to the permission information of the initial user. In the implementation, it may be determined by judging whether the service information of the operation target and the IP of the operation target in the operation/access request are in the permission information list of the initial user. Further, it may be inquired that whether the IP of the operation target is an operable port by the operation target application, and if it is, the target information in the operation/access request is determined to be legitimate. If positive results are obtained in all of step 103 to step 105, the operation/access request of the calling party is determined to be legitimate; further, the operation/access request of the calling party can be responded to, and the operation result can be returned to the calling party. If the session information of the calling party is found illegitimate in step 103, a message indicating that the session times out or is inexistent will be returned. If the operation information or the target information of the operation/access request is determined illegitimate, an operation failure message is returned to the calling party.

Step S107 is: determining whether the session information is legitimate. This step is same as step 103 which herein would not describe in detail.

Step S108 is: obtaining permission information of the calling party according to the ongoing session information. Similarly as step 104, the permission information of the calling party may be a permission information list affirmed by the cloud platform service when the calling party logs in. For example, the permission information of the calling party may be obtained, with the session information of the calling party and the login authentication result together, by the target cloud platform service from the account authentication system when the calling party logs in the target cloud platform service. The content of the permission information may include the permission for the type of the operation corresponding to the calling party, a plurality of operable target services (such as appid), and the operating ranges of the operable target services (for example, the ranges may be expressed using IP).

Step S109 is: determining whether the operation information and the target information of the operation/access request is legitimate according to the permission information of the calling party. In the implementation, it may be determined by judging whether the operation information and the target information in the operation/access request are in the permission information list of the calling party, and if they are, the operation information and the target information of the operation/access request is confirmed legitimate.

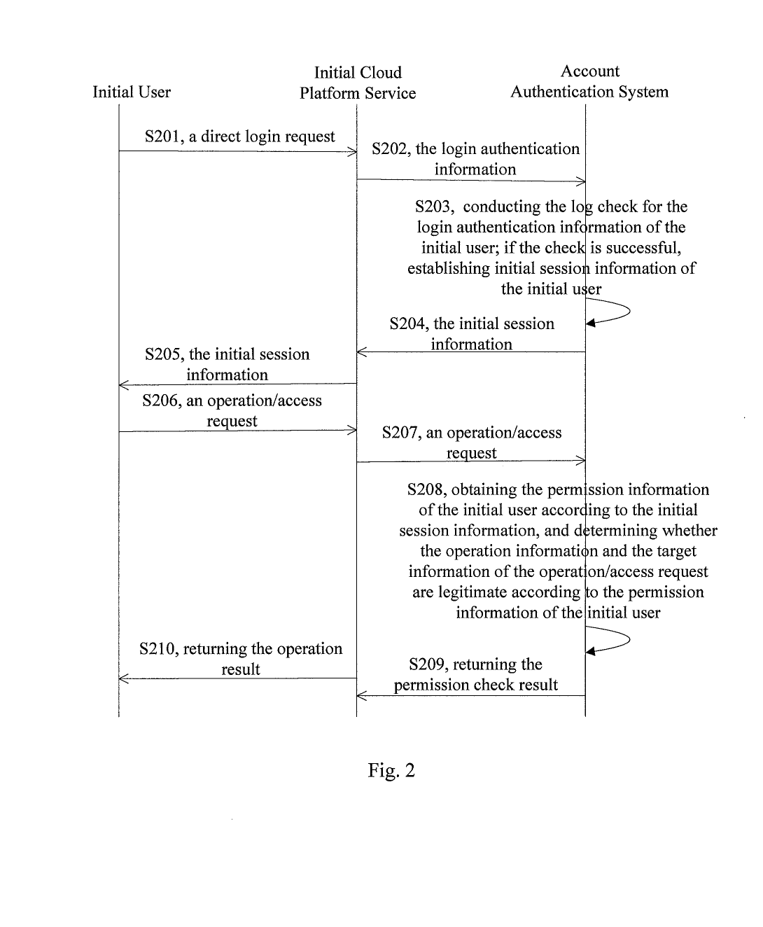

FIG. 2 is a flowchart of a permission management method for a cloud platform service according to another embodiment of the present invention. In the present embodiment, it is described a permission management process of directly calling a cloud platform service, and the caller is just the initial user. As shown in FIG. 2, the method of the present embodiment may comprise steps S201-S210.

In step S201, the initial user sends a direct login request to an initial cloud platform service, the direct login request including login authentication information of the initial user. The login authentication information may include a user name, a password of the initial user, etc. In the embodiment of the present invention, the initial user may communicate with and obtain service from the cloud platform service with a personal computer, mobile terminal, etc.

In step S202, the initial cloud platform service sends the login authentication information of the initial user to an account authentication system. In other optional embodiments, the cloud platform service may independently accomplish the login authentication process without the check by the account authentication system.

In step S203, the account authentication system conducts the login check for the login authentication information of the initial user, and if the login check is successful, initial session information of the initial user is established. The login check for the login authentication information of the initial user may performed by comparing the login authentication information with pre-stored login authentication information, and if they are consistent, the check is successful. The initial session information may include user information of the initial user (such as a user name, a password, etc), a session ID (used to easily search for the session information), and so on. The validity period of the initial session information may be set as being valid during the ongoing login, being valid for one day, being valid for one week, etc. When the validity period is past, the initial session information will be invalid.

In step S204, the account authentication system returns the initial session information to the initial cloud platform service.

In step S205, the initial cloud platform service returns the initial session information to the initial user.

In step S206, the initial user sends an operation/access request to the initial cloud platform service, the operation/access request including operation information, target information, and the initial session information of the initial user.

In step S207, the initial cloud platform service sends the operation/access request to the account authentication system. In other optional embodiments, the cloud platform service may also independently accomplish the permission check process for the operation/access request of the user without the check by the account authentication system.

In step S208, the account authentication system conducts a permission check for the operation/access request, which includes: determining whether the initial session information is legitimate; obtaining the permission information of the initial user according to the initial session information; and determining whether the operation information and the target information of the operation/access request are legitimate according to the permission information of the initial user. Wherein, whether the initial session is legitimate is determined by judging whether the initial session information is consistent with the initial session information established when the initial user logs in, and if they are consistent, the initial session is legitimate. Further, it is determined that whether the operation information and the target information of the operation/access request is in the permission information list of the initial user, and if it is, the operation information and target information of the operation/access request is determined to be legitimate.

In step S209, the account authentication system returns the permission check result to the initial cloud platform service.

In step S210, the initial cloud platform service returns the operation result to the initial user. Specifically, if in the permission check result, it is determined that the operation/access request of the initial user is legitimate, the operation/access request of the calling party is responded to, and further, the operation result is returned to the calling party, namely, the initial user. If in the permission result, it is determined that the initial session information is illegitimate, a message indicating that the session times out or is inexistent is returned to the initial user. If in the permission check result, it is determined that the operation information and the target information of the operation/access information are illegitimate, an operation failure message is returned to the initial user.

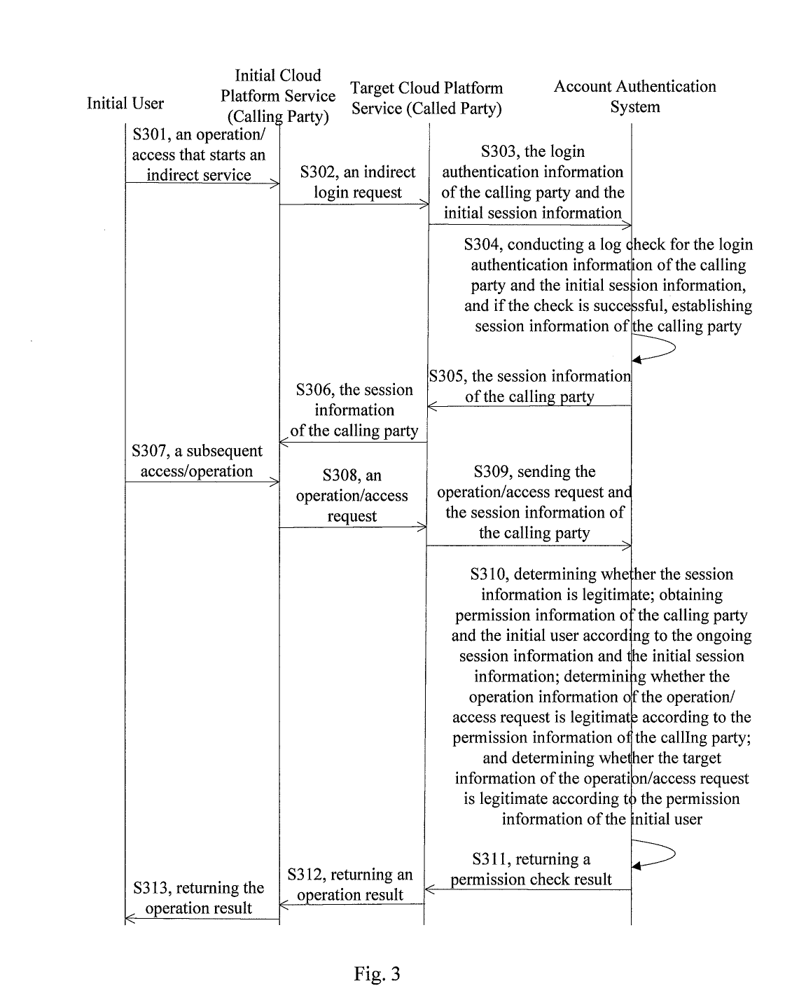

FIG. 3 is a flowchart of a permission management method for a cloud platform service according to yet another embodiment of the present invention. In the embodiment, it is described a permission management process of indirectly calling a cloud platform service. An initial user logs in another cloud platform service and then becomes a caller. As shown in FIG. 3, the method of the present embodiment may include steps S301 to S313.

In step S301, the initial user sends to an initial cloud platform service an operation/access that starts an indirect service. In the implementation, the initial user may have finished the login process to the initial cloud platform service beforehand. The operation/access that starts the indirect service carries initial session information of the initial user, operation information, and target information, wherein the initial session information is obtained during the process that the initial user logs in the initial cloud platform service. The initial session information may include user information of the initial user, a session identifier, a session source IP, a session destination IP, etc. The operation information and/or the target information need to call resources of a target cloud platform service.

In step S302, the initial cloud platform service sends an indirect login request to the target cloud platform service according to the operation/access of the initial user. The indirect login request includes login authentication information of the calling party and the initial session information. The login authentication information may be a login user name and a password that the initial user inputs via the initial cloud platform service.

In step S303, the target cloud platform service sends the login authentication information of the calling party and the initial session information to an account authentication system.

In step S304, the account authentication system conducts a login check for the login authentication information of the calling party and the initial session information, wherein the login authentication information of the calling party and the initial session information may be compared with pre-stored login authentication information and the initial session information. If they are consistent, the login check is successful. Further, if the initial session information is stored in an external system instead of the account authentication system, the account authentication system may conduct an external check in the external system storing the initial session information. If the login check is successful, session information of the calling party is generated, the session information including the ongoing session information of the calling party and the initial session information, wherein the ongoing session information of the calling party may include a user name of the calling party, a session identifier, a session source IP, a session destination IP, and so on.

In step S305, the account authentication system returns the session information of the calling party to the target cloud platform service. Specifically, after the account authentication system conducts the login check for the login authentication information and the initial session information sent by the target cloud platform service, no matter the check is successful or not, the check result will be sent to the target cloud platform service. If the check is successful, the check result carrying the session information of the calling party is returned to the target cloud platform service. Optionally, the check result may carry the permission information of the calling party and the permission information of the initial user at the same time.

In step S306, the target cloud platform returns the session information of the calling party to the initial cloud platform service. Specifically, the target cloud platform service returns the check result of the indirect login request to the initial cloud platform service. If the login check is successful, the obtained session information of the calling party is returned to the initial cloud platform service.

In step S307, the initial user sends a subsequent access/operation to the initial cloud platform service, the subsequent access/operation carrying the initial session information of the initial user, operation information, and target information, wherein the operation information and/or target information need to call resources of the target cloud platform service.

In step S308, the initial cloud platform service sends an operation/access request to the target cloud platform service, the operation/access request including operation information, target information, and session information of the calling party, and the session information of the calling party including the ongoing information of the calling party and initial session information.

In step S309, the target cloud platform service sends an indirect service authentication request to the account authentication system, and the indirect service authentication request includes the operation/access request and the session information of the calling party.

In step S310, the account authentication system conducts a permission check for the operation/access request and the session information of the calling party.

Furthermore, the permission check of the present embodiment may include the following steps.

1) It is determined that whether the session information is legitimate. In the implementation, it is judged that whether the session information of the operation/access request is consistent with the session information established by the initial cloud platform service when the calling party logs in. If it is, the session is determined to be legitimate, and otherwise illegitimate.

2) It is obtained that permission information of the calling party and the initial user according to the ongoing session information and the initial session information. The permission information of the calling party and the permission information of the initial user may be affirmed by the account authentication system according to user information of the calling party and user information of the initial user during the process that the calling party logs in the target cloud platform service. The content of the permission information includes permissions for the types of operations corresponding to the calling party and the initial user, respectively, a plurality of operable target services (such as appid), an operating ranges of the operable target services (for example, the ranges may be expressed using IP), etc.

3) It is determined that whether the operation information of the operation/access request is legitimate according to the permission information of the calling party. In the implementation, whether the operation information of the operation/access request is in the permission information list is judged, and if it is, the operation information is determined to be legitimate, for example, a legitimate operation type.

4) It is determined that whether the target information of the operation/access request is legitimate according to the permission information of the initial user. In the implementation, whether the service information of the operation target and the IP of the operation target in the operation/access request are in the permission information list of the initial user is judged. Further, it may be inquired that whether the IP of the operation target is a port operable by the operation target application, and if it is, the target information in the operation/access request is determined to be legitimate.

If the checks of the above three steps are all successful, the account authentication system conducts a permission check for the operation/access request and session information of the calling party.

In step S311, the account authentication system returns a permission check result to the target cloud platform service.

In step S312, the target cloud platform service returns an operation result to the initial cloud platform service according to the permission result returned by the account authentication system. Specifically, if the account authentication system determines that the operation/access request of the calling party is legitimate, the target cloud platform service may respond the operation/access request of the calling party, and further the operation result is returned to the calling party. If the permission check result returned by the account authentication system determines that the session information of the calling party is illegitimate, the target cloud platform service may return a message indicating that the session times out or is inexistent to the calling party. If the permission check result returned by the account authentication system determines that the operation information or the target information of the operation/access request is illegitimate, the target cloud platform returns an operation failure message to the calling party.

In step S313, the initial cloud platform service returns the operation result to the initial user.

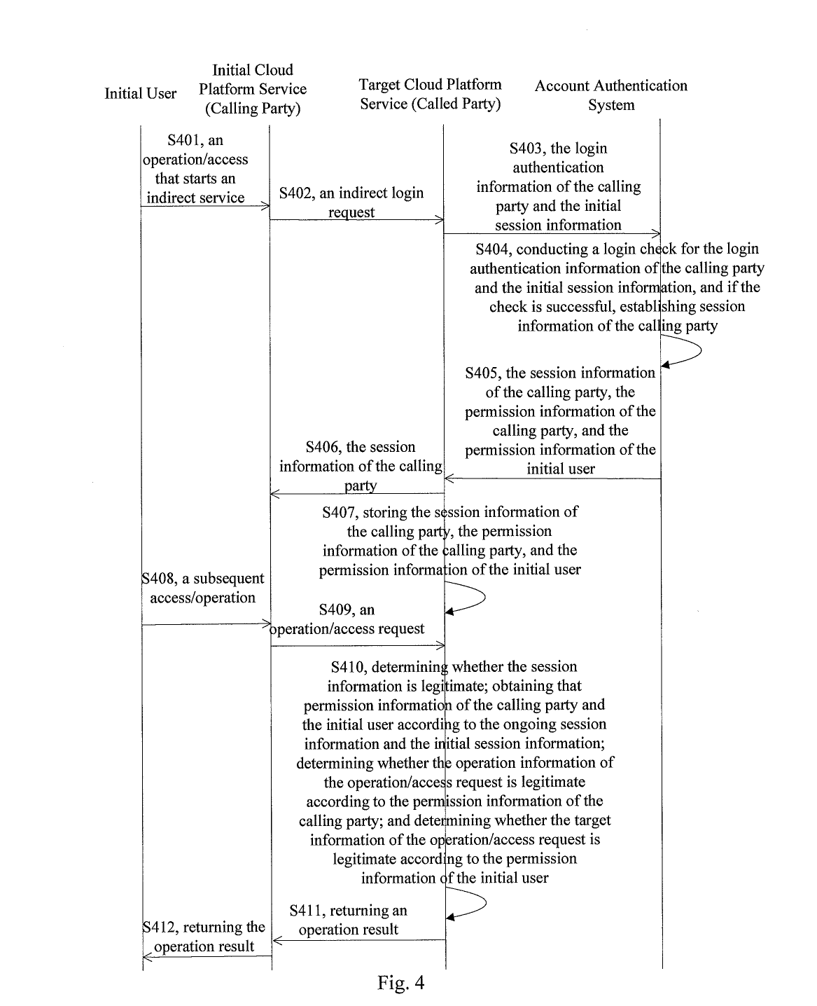

FIG. 4 is a flowchart of a permission management method for a cloud platform service according to yet another embodiment of the present invention. In the embodiment, it is described another permission management process for a cloud platform service that is called indirectly. An initial user logs in another cloud platform service and then becomes the caller. As shown in FIG. 4, the method of the present embodiment may include steps S401 to S412.

Step S401 to step S403 are similar as step 301 to step 303 in the above embodiment, which would not be described here to avoid redundancy.

In step S404, the account authentication system conducts a login check for the login authentication information of the calling party and the initial session information, wherein the login authentication information of the calling party and the initial session information may be compared with a pre-stored login authentication information and the initial session information. If they are consistent, the login check is successful. Further, if the initial session information is stored in an external system instead of the account authentication system, the account authentication system may conduct an external check in the external system storing the initial session information. If the login check is successful, session information of the calling party including the ongoing session information of the calling party and the initial session information is generated, and the permission information of the calling party and the initial user are affirmed according to the ongoing session information of the calling party and the initial session information.

In step S405, the account authentication system returns the session information of the calling party, the permission information of the calling party, and the permission information of the initial user to the target cloud platform service. Specifically, after the account authentication system conducts the login check for the login authentication information and the initial session information sent by the target cloud platform service, no matter the check is successful or not, the check result will be sent to the target cloud platform service. If the check is successful, the check result carrying the session information of the calling party, the permission information of the calling party, and the permission information of the initial user is returned to the target cloud platform service.

In step S406, the target cloud platform returns the session information of the calling party to the initial cloud platform service. Specifically, the target cloud platform service returns the check result of the indirect login request to the initial cloud platform service, and if the login check is successful, the obtained session information of the calling party is returned to the initial cloud platform service.

Step S407 is: the target cloud platform service stores the session information of the calling party, the permission information of the calling party, and the permission information of the initial user that are returned by the account authentication system.

In steps S408 to S409, the initial user sends a subsequent access/operation to the initial cloud platform service, and the initial cloud platform service sends the operation/access request to the target cloud platform service. These are similar as steps S307 to S308 in the above embodiment, which would not describe here to avoid redundancy.

In step S410, the target cloud platform service conducts a permission check for the obtained operation information of the operation/access request and the session information of the calling party. Since in step S407 in the present embodiment, the target cloud platform has locally stored the obtained session information of the calling party, permission information of the calling party, and the permission information of the initial user when the calling party logs in, the permission check for the operation/access request may be locally conducted. Further, the permission check in the present embodiment may include the following steps.

1) It is determined that whether the session information is legitimate. In the implementation, the target cloud platform service judges whether the session information of the operation/access request is consistent with the session information established when the calling party logs in. If it is, it is determined that the session is legitimate, and otherwise illegitimate.

2) It is obtained that permission information of the calling party and the initial user according to the ongoing session information and the initial session information. The permission information of the calling party and the permission information of the initial user may be a permission information list affirmed by the target cloud platform service for the ongoing login of the calling party. In the present embodiment, the permission information of the calling party and the permission information of the initial user may be obtained by the target cloud platform service from the account authentication system when the calling party logs in the target cloud platform service, and the content of the permission information includes permissions for the types of operations corresponding to the calling party and the initial user, respectively, a plurality of operable target services (such as appid), the operating ranges of the operable target services (for example, the ranges may be expressed using IP), etc.

3) It is determined that whether the operation information of the operation/access request is legitimate according to the permission information of the calling party. In the implementation, the target cloud platform service judges whether the operation information included in the operation/access request is in the permission information list of the permission information of the calling party, and if it is, the operation information is determined to be legitimate, for example, a legitimate operation type.

4) It is determined that whether the target information of the operation/access request is legitimate according to the permission information of the initial user. In the implementation, the target cloud platform service judges whether the service information of the operation target and the IP of the operation target included in the operation/access request is in the permission information list of the initial user. Further, it may be inquired that whether the IP of the operation target is a port operable by the operation target application. If positive results are obtained in all of them, the target information in the operation/access request is determined to be legitimate.

If the three check steps mentioned above are successful, the permission check for the operation/access request and session information of the calling party is passed in the target cloud platform service.

In step S411, the target cloud platform service returns an operation result to the initial cloud platform service according to the permission check results. Specifically, if the target cloud platform service determines that the operation/access request of the calling party is legitimate in step 410, the target cloud platform service may respond to the operation/access request of the calling party, and then returns the operation result to the calling party. If the target cloud platform determines that the session information of the calling party is illegitimate in step 410, the target cloud platform service may return a message indicating that the session times out or is inexistent to the calling party. If the target cloud platform determines that the operation information or target information of the operation/access request is illegitimate, the target cloud platform service may return an operation failure message to the calling party.

Step S412 is: the initial cloud platform returns the operation result to the initial user.

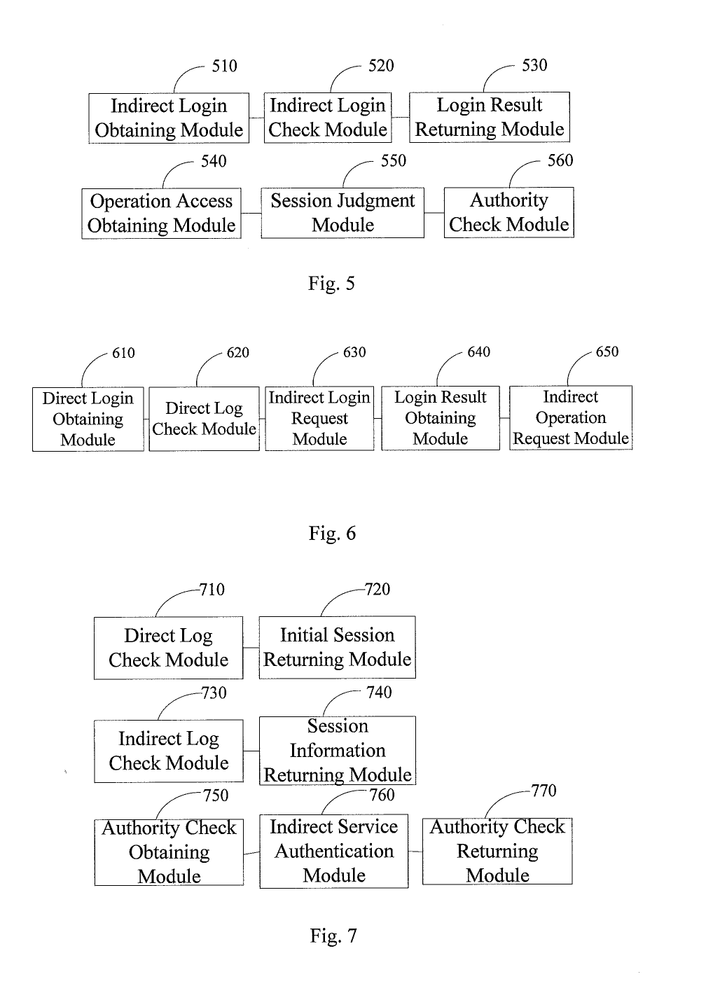

FIG. 5 is a structural diagram of a permission management device for a cloud platform service according to yet another embodiment of the present invention. The permission management device may be realized in the background of a target cloud platform service that is indirectly called. As shown in FIG. 5, the permission management device may includes: an indirect login obtaining module 510, an indirect login authentication module 520, an login result returning module 530, an operation/access obtaining module 540, a session judgment module 550 and permission check module 560.

The indirect login obtaining module 510 is configured to obtain an indirect login request of the calling party, the indirect login request including the login authentication information of the calling party and the initial session information. In the implementation, the initial user utilizes an initial cloud platform service and therefore serves as a calling party sending the indirect login request. The login authentication information may be a user name, a password, etc. input by the initial user logs in the initial cloud platform service. The initial session information is the session information obtained during the process that the initial user logs in the initial cloud platform service which the calling party belongs to. The initial session information may include user information of the initial user, a session identifier, a session source IP, a session destination IP, etc. The initial session information is used for communication session between the initial user and the initial cloud platform service after the calling party has successfully logged in. The login authentication information may be a login user name and a password used to log in the target cloud platform, which are input by the initial user via the initial cloud platform service.

The indirect login check module 520 is configured to conduct a login check for the login authentication information of the calling party and the initial session information. If the login check is successful, the session information of the calling party, the permission information of the calling party, and the permission information of the initial user are obtained. Specifically, the indirect login check module 520 may compare the login authentication information of the calling party and the initial session information with pre-stored login authentication information and the initial session information. If they are consistent, the check is successful. Further, if the initial session information is stored in an external system instead of the account authentication system, the indirect login check module 520 may conduct an external check in the external system storing the initial session information. If the login check is successful, the session information of the calling party is obtained. Further, the permission information of the calling party and the initial user is obtained according to the session information of the calling party. Optionally, the indirect login check module 520 may include: a login check request unit, a session information obtaining unit.

The login check request unit is configured to send the login authentication information of the calling party and the initial session information to the account authentication system, so that the account authentication system conducts a check for the login authentication information of the calling party and the initial session information, wherein if the check is successful, the account authentication system will establish the session information of the calling party.

The session information obtaining unit is configured to obtain the session information of the calling party, the permission information of the calling party, and the permission information of the initial user from the account authentication system. Namely, the indirect login check module 520 may give the login check to the account authentication system to let the account authentication system accomplish the login check. When the indirect login request of the calling party is received, the login authentication information of the calling party and the initial session information are sent to the account authentication system to conduct the login check by the login check request unit, and then the login check result is obtained from the account authentication system by the session information obtaining unit. If the check is successful, the session information of the calling party may be obtained from the account authentication system, and further the permission information of the calling party and the permission information of the initial user may be obtained.

The login result returning module 530 is configured to return the session information to the calling party. Specifically, the login result returning module 530 may return the check result of the indirect login request to the initial cloud platform service where the calling party belongs to. If the login check is successful, the obtained session information of the calling party is returned to the initial cloud platform service.

The operation/access obtaining module 540 is configured to obtain the operation/access request of the calling party, wherein the operation/access request includes operation information, target information, and session information of the calling party, and the target information of the calling party includes the initial session information of the calling party.

The session judgment module 550 is configured to determine whether the session information includes the initial session information of the calling party and the initial session information is valid. In the embodiment, if the session information of the calling party doesn't include the initial session information of the calling party or the initial session information is invalid, the calling party is an initial user and the call is a direct call. Otherwise, the calling party is an indirect user. For example, the initial user sends an operation/access request to the target cloud platform service by the initial cloud platform service, the initial session information of the initial user is the session information obtained during the process that the initial user logs in the initial cloud platform service which the calling party belongs to. The initial session information is used for communication session between the initial user and the initial cloud platform service after the user has logged in. The initial session information may include user information of the initial user, a session identifier, a session source IP, a session destination IP, and so on. Whether the initial session information is valid may be judged by judging whether the session identifier of the initial session information is valid. For example, if the session identifier is zero or null, it is invalid. Further, the initial session information can be determined to be invalid, and otherwise valid. Or, whether the initial session information is consistent with the ongoing session information of the calling party is judged. If they are consistent, the initial session information is confirmed invalid, and otherwise valid.

The permission check module 560 is configured to conduct a permission check for the operation/access request.

In the implementation, if the target cloud platform service locally stores the obtained session information of the calling party, the permission information of the calling party, and the permission information of the initial user, the permission check module 560 may locally accomplish the permission check. Otherwise, the operation/access request may be sent to the account authentication system to conduct the permission check. If the session judgment module 550 determines that the session information includes the initial session information of the calling party and the initial session information is valid, the permission check may includes the following steps.

1) It is determined that whether the session information is legitimate. In the implementation, it is judged that whether the session information of the operation/access request is consistent with the session information established when the calling party logs in. If it is, the session is determined to be legitimate, and otherwise illegitimate. It should be noted that, in optional embodiments, the permission check module 560 may firstly determines that the session information is legitimate, and then the session judgment module 550 judges whether the session information includes the initial session information of the calling party.

2) It is obtained that permission information of the calling party and the initial user according to the ongoing session information and the initial session information. The permission information of the calling party and the permission information of the initial user may be obtained by the indirect login check module 520 during the process that the calling party logs in the target cloud platform service. The content of the permission information includes permissions for the types of operations corresponding to the calling party and the initial user, respectively, a plurality of operable target services (such as appid), an operating ranges of the operable target services (for example, the ranges may be expressed using IP), etc.

3) It is determined that whether the operation information of the operation/access request is legitimate according to the permission information of the calling party. In the implementation, whether the operation information of the operation/access request is in the permission information list is judged, and if it is, the operation information is determined to be legitimate, for example, a legitimate operation type.

4) It is determined that whether the target information of the operation/access request is legitimate according to the permission information of the initial user. In the implementation, whether the service information of the operation target and the IP of the operation target in the operation/access request are in the permission information list of the initial user is judged. Further, it may be inquired that whether the IP of the operation target is a port operable by the operation target application, and if it is, the target information in the operation/access request is determined to be legitimate.

On the other hand, if the session judgment module 550 determines the session information doesn't include the initial session information of the calling party or the initial session information is invalid, the permission check module 560 conducts the permission check for the operation/access request, which may include the following steps.

1) It is determined that whether the session information is legitimate. In the implementation, it is judged that whether the session information of the operation/access request is consistent with the session information established when the calling party logs in. If it is, the session is determined to be legitimate, and otherwise illegitimate. It should be noted that, in optional embodiments, the permission check module 560 may firstly determines that the session information is legitimate, and then the session judgment module 550 judges whether the session information includes the initial session information of the calling party.

2) It is obtained that permission information of the calling party according to the ongoing session information. The permission information of the calling party may be obtained by the indirect login check module 520 during the process that the calling party logs in the target cloud platform service. The content of the permission information includes a permission for the types of operations corresponding to the calling party, a plurality of operable target services (such as appid), an operating ranges of the operable target services (for example, the ranges may be expressed using IP), etc.

3) It is determined that whether the operation information of the operation/access request is legitimate according to the permission information of the calling party. In the implementation, whether the operation information and the target information included in the operation/access request are in the permission information list is judged, and if they are, the operation information and the target information is determined to be legitimate.

In optional embodiments, the permission check module 560 may further includes: a permission check request unit, a permission check obtaining unit.

The permission check request unit is configured to send an indirect service authentication request to the account authentication system, wherein the indirect service authentication request includes the operation/access request and the session information of the calling party, so that the account authentication system conducts an permission check for the operation/access request and the session information of the calling party. Specifically, when the session information of the calling party, the permission information of the calling party, and the permission information of the initial user are stored in the target cloud platform service instead of stored locally, the permission check module 560 of the target cloud platform service may send the indirect service authentication request to the account authentication system by the permission check request unit to conduct the above mentioned permission check.

The permission check obtaining unit is configured to obtain the result of the permission check from the account authentication system.

FIG. 6 is a structural diagram of a calling device for a cloud platform service according to yet another embodiment of the present invention. The calling device in the present embodiment may be realized in the background of an initial cloud platform service which starts an indirect call to a target cloud platform service according to an operation/access by an initial user who has been logged in. As shown in the figure, the calling device in the present embodiment may include: a direct login obtaining module 610, a direct login check module 620, an indirect login request module 630, a login result results obtaining module 640 and an indirect operation request module 650.

The direct login obtaining module 610 is configured to obtain the direct login request of the initial user, wherein the direct login request includes login authentication information of the initial user, and the login authentication information may include a user name and password of the initial user, etc. In the embodiment, the initial user may communicate with and obtain service from the cloud platform service with a personal computer, a mobile terminal, etc.

The direct login check module 620 is configured to conduct a login check for the login authentication information of the initial user; and if the login check is successful, the initial session information of the initial user is obtained. The initial session information may include user information of the initial user, a session identifier, a session source IP, a session destination IP, etc, which are used for communication session between the initial user and the initial cloud platform service after the user has logged in successfully. In the present embodiment, the direct login check module 620 may further include a login check request unit and an initial session obtaining unit.

The login check request unit is configured to send the login authentication information of the initial user to the account authentication system, so that the account authentication system checks the login authentication information of the initial user. If the permission check is successful, the account authentication system establishes the initial session information of the initial user. In the implementation, the login check for the login authentication information of the initial user conducted by the account authentication system may be performed by comparing the login authentication information of the initial user with pre-stored login authentication information, and if they are consistent, the check is successful. The initial session information may include user information of the initial user (such as a user name, password, etc), a session ID (used to easily search for the session information), and so on. The validity period of the initial session information may be set as being valid during the ongoing login, being valid for one day, being valid for one week, etc. When the validity period is past, the initial session information will be invalid.

The initial session obtaining unit is configured to obtain the initial session information from the account authentication system after the permission check for the login authentication information of the initial user conducted by the account authentication system is successful.

It should be noted that, in other optional embodiments, the direct login check module 620 may independently accomplish the login check process of the user without the login check conducted by the account authentication system.

The indirect login request module 630 is configured to send an indirect login request to the target cloud platform service, wherein the indirect login request includes the login authentication information of the calling party and the initial session information, so that the target cloud platform service conducts the login check for the login authentication information of the calling party and the initial session information. The login authentication information may be a login user name and a password input by the initial user via the initial cloud platform service.

The login result obtaining module 640 is configured to obtain the session information of the calling party from the target cloud platform service after the login check of the target cloud platform service is successful. In the implementation, after the target cloud platform service conducts the login check for the login authentication information of the calling party and the initial session information, if the login check is successful, the session information of the calling party will be obtained or established from the account authentication system, and the indirect login check result will be sent to the login result obtaining module 640 of the calling device for the cloud platform service. The session information of the calling party includes ongoing session information and initial session information of the calling party.

The indirect operation request module 650 is configured to send an operation/access request to a target cloud platform service, wherein the operation/access request includes operation information, target information, and session information of the calling party, and the session information of the calling party includes the ongoing session information of the calling party and the initial session information, so that the target cloud platform service conducts a permission check for the operation/access request according to the session information of the calling party. In the implementation, when the initial user passes beforehand and accomplishes the login to the initial cloud platform service, the initial user obtains the initial session information from the direct login check module 620 and then sends to the initial cloud platform service the operation/access starting the indirect service, which carries the initial session information of the initial user, operation information, and target information. The operation information and/or the target information need to call resources of the target cloud platform service. The indirect operation request module 650 sends the operation/access request to the target cloud platform service according to the operation/access sent by the initial user. The operation/access request includes the operation information, the target information and the session information of the calling party. After the target cloud platform service obtains the operation/access request, it is determined that whether the session information is legitimate. Further, the permission information of the calling party and the initial user are obtained according to the ongoing session information and the initial session information. Then, whether the operation information of the operation/access request is legitimate is determined according to the permission information of the calling party, and whether the target information of the operation/access request is legitimate is determined according to the permission information of the initial user.

FIG. 7 is a structural diagram of an account authentication system for a cloud platform service according to yet another embodiment of the present invention. As shown in FIG. 7, the account authentication system in the embodiment of the present invention may include: a direct login check module 710, an initial session returning module 720, an indirect login check module 730, a session information returning module 740, a permission check obtaining module 750 and an indirect service authentication module 760.

The direct login check module 710 is configured to obtain the login authentication information of the initial user of the calling party sent by the target cloud platform service which the calling party belongs to, and conduct a login check for the login authentication information of the initial user. If the login check is successful, the initial session information of the initial user is established. In the implementation, the login check for the login authentication information of the initial user may be performed by comparing the login authentication information with pre-stored login authentication information, if they are consistent, the login check is successful. The initial session information may include user information of the initial user (such as user name, password, etc), a session ID (randomly generated, used to easily search for the session information), and so on. The validity period of the initial session information may be set as being valid during the ongoing login, being valid for one day, being valid for one week, etc. When the validity period is past, the initial session information will be invalid.

The initial session returning module 720 is configured to send the initial session information to the cloud platform service which the calling party belongs to.

The indirect login check module 730 is configured to obtain login authentication information of the calling party and initial session information from the target cloud platform service, and conduct a check for the login authentication information of the calling party and the initial session information. If the check is successful, the session information of the calling party is established. The permission information of the calling party and the initial user may also be affirmed according to the session information of the calling party, the session information of the calling party including the ongoing session information of the calling party and the initial session information. In the implementation, the login authentication information of the calling party and the initial session may be compared with pre-stored login authentication information and the initial session information in the account authentication system. If they are consistent, the check is successful. Further, if the initial session information is stored in an external system instead of the account authentication system, the indirect login check module 730 may conduct an external check in the external system storing the initial session information. If the login check is successful, the session information of the calling party is generated. The ongoing session information is used for communication session between the calling party and the target cloud platform service after the user has logged in. The ongoing session information may include user information of the calling party, a session identifier, a session source IP, a session destination IP, etc. The initial session information may be session information obtained during the process that the initial user logs in the initial cloud platform service that the calling party belongs to. The initial session information may include user information of the initial user, a session identifier, a session source IP, a session destination IP, etc. The initial session information is used for communication session between the initial user and the initial cloud platform service after the user has logged in successfully.

The session information returning module 740 is configured to return the session information of the calling party to the target cloud platform service. Further, the session information returning module may also return the permission information of the calling party and the initial user to the target cloud platform service. Specifically, after the session information returning module 740 conducts the login check for the login authentication information and the initial session information sent by the account authentication system to the target cloud platform service, no matter the check is successful or not, the check result will be sent to the target cloud platform service. If the check is successful, the check result carrying the session information of the calling party, the permission information of the calling party, and the permission information of the initial user is returned to the target cloud platform service.

The permission check obtaining module 750 is configured to obtain an indirect service authentication request from the target cloud platform service, wherein the indirect service authentication request includes an operation/access request of a calling party and session information of the calling party, and the session information of the calling party includes ongoing session information of the calling party and initial session information.

The indirect service authentication module 760 is configured to conduct a permission check for the operation/access request of the calling party and the session information of the calling party, wherein the permission check may comprise the following steps.

1) It is determined that whether the session information is legitimate. In the implementation, it is judged that whether the session information of the operation/access request is consistent with the session information established by the initial cloud platform service when the calling party logs in. If it is, the session is determined to be legitimate, and otherwise illegitimate.

2) It is obtained that permission information of the calling party and the initial user according to the ongoing session information and the initial session information. The content of the permission information of the calling party and the permission information of the initial user may include permissions for the types of operations corresponding to the calling party and the initial user, respectively, a plurality of operable target services (such as appid), an operating ranges of the operable target services (for example, the ranges may be expressed using IP), etc.

3) It is determined that whether the operation information of the operation/access request is legitimate according to the permission information of the calling party. In the implementation, whether the operation information of the operation/access request is in the permission information list is judged, and if it is, the operation information is determined to be legitimate, for example, a legitimate operation type.

4) It is determined that whether the target information of the operation/access request is legitimate according to the permission information of the initial user. In the implementation, whether the service information of the operation target and the IP of the operation target in the operation/access request are in the permission information list of the initial user is judged. Further, it may be inquired that whether the IP of the operation target is a port operable by the operation target application, and if it is, the target information in the operation/access request is determined to be legitimate.

The permission authentication returning module 770 is configured to return the permission check result to the target cloud platform service.

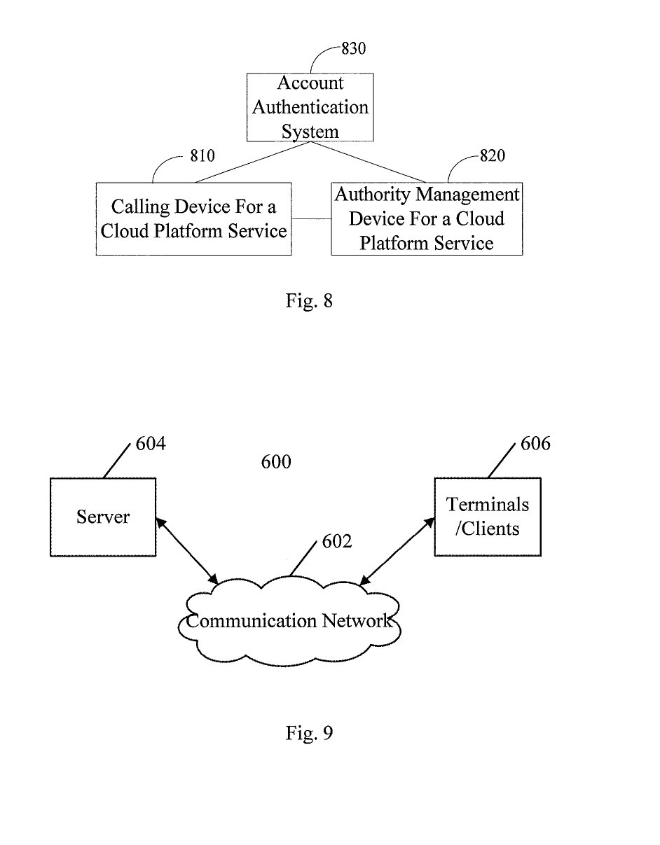

FIG. 8 is a structural diagram of a permission management system for a cloud platform service according to yet another embodiment of the present invention. As shown in FIG. 8, the permission management system for the cloud platform service in the embodiment may include at least a permission management device 810 for the cloud platform service and a calling device 820 for the cloud platform service.

The calling device for a cloud platform service 810 may be the calling device for the cloud platform service described in the above embodiments in combination with FIG. 6, and may be realized in the background of an initial cloud platform service which starts an indirect call to a target cloud platform service according to an operation/access by an initial user who has been logged in. The calling device for a cloud platform service 810 is configured to send an operation/access request to the target cloud platform service. The operation/access request includes operation information, target information and the session information of the calling party. The session information of the calling party includes the ongoing session information.

The permission management device for the cloud platform service 820 may be a permission management device for a cloud platform service described in the above embodiment in combination with FIG. 5, and may be realized in the background of a target cloud platform service that is indirectly called. The permission management device for a cloud platform service 820 is configured to: obtain the operation/access request sent by the calling device 810; confirm the session information includes the initial session information of the calling party and the initial session information is effective; conduct an permission check for the operation/access request, wherein the permission check includes: confirming whether the session information is legitimate; obtaining the permission information of the calling party and the initial user according to the ongoing session information and the initial session information, respectively; confirming whether the operation information of the operation/access request is legitimate according to the permission information of the calling party; confirming the target information of the operation/access request is legitimate according to the permission information of the initial user.

Further optionally, the permission management system for the cloud platform service in the embodiment of the present invention may also include an account authentication system 830, which may be the account authentication system described in the above embodiment in combination with FIG. 7. The account authentication system is configured to obtain an indirect service authentication request from the permission management device for the cloud platform service 820. The indirect service authentication request includes the operation/access request of the calling party and the session information of the calling party. The account authentication system conducts a permission check for the operation/access request and the session information of the calling party, and returns the permission check result to the permission management device for a cloud platform service.

In the embodiment, when an operation/access request is sent to indirectly call resources of the target cloud platform service, the initial session information of the calling party is carried in the operation/access request. Therefore, the target cloud platform service can check for two parties, i.e. the direct calling party and the initial user, so as to ensure that the operation/access request is within a legitimate range and guarantee the overall security of the cloud platform service and the third resource in complex environments of cloud platform.

Persons of ordinary skilled in the art should understand that all or part of the steps of the method in the embodiments of the present disclosure may be implemented by a program instructing relevant hardware. The program may be stored in a computer-readable storage medium accessible by a processor in a server. The storage medium may be ROM/RAM, magnetic disk, or CD-ROM.

The foregoing descriptions are merely exemplary embodiments of the present invention, but not intended to limit the protection scope of the present invention. Any variation or replacement made by persons of ordinary skills in the art without departing from the spirit of the present invention shall fall within the protection scope of the present invention.

1. A permission management method for a cloud platform service, comprising the steps of:
obtaining, by a target cloud platform service, an operation/access request of a calling party, wherein the operation/access request includes operation information, target information, and session information of the calling party, and the target information of the calling party includes an ongoing session information;
determining, by the target cloud platform service, that the session information includes an initial session information of the calling party and the initial session information is valid; and
conducting, by the target cloud platform service, a permission check for the operation/access request,
wherein the permission check comprises:
determining whether the session information is legitimate;
obtaining permission information of the calling party and an initial user according to the ongoing session information and the initial session information, respectively;
determining whether the operation information of the operation/access request is legitimate according to the permission information of the calling party; and
determining whether the target information of the operation/access request is legitimate according to the permission information of the initial user.

2. The permission management method as claimed in claim 1, before obtaining the operation/access request of the calling party, further comprising:
obtaining, by the target cloud platform service, an indirect login request of the calling party, wherein the indirect login request includes login authentication information of the calling party and an initial session information;
conducting, by the target cloud platform service, a login check for the login authentication information of the calling party and the initial session information, and if the login check is successful, obtaining the session information of the calling party, the permission information of the calling party and the initial user; and
returning, by the target cloud platform service, the session information to the calling party.

3. The permission management method as claimed in claim 2, wherein the step of conducting, by the target cloud platform service, a login check for the login authentication information of the calling party and the initial session information, and if the login check is successful, obtaining the session information of the calling party, the permission information of the calling party and the initial user, comprises:
sending, by the target cloud platform service, the login authentication information and the initial session information of the calling party to an account authentication system; and
checking, by the account authentication system, the login authentication information and the initial session information of the calling party, and if the login check is successful, establishing the session information of the calling party, and returning the permission information of the calling party and the initial user to the target cloud platform service.

4. The permission management method as claimed in claim 1, wherein the step of conducting, by the target cloud platform service, the permission check for the operation/access request, comprises:
sending, by the target cloud platform service, an indirect service authentication request to the account authentication system, wherein the indirect service authentication request includes the operation/access request and the session information of the calling party; and
conducting, by the account authentication system, a permission check for the operation/access request and the session information of the calling party, and returning the result of the permission check to the target cloud platform service.

5. The permission management method as claimed in claim 1, before obtaining a login request of the calling party, further comprising:
obtaining, by an initial cloud platform service which the calling party belongs to, a direct login request of the initial user, wherein the direct login request includes login authentication information of the initial user; and
conducting, by the initial cloud platform service which the calling party belongs to, a login check for the login authentication information, and if the login check is successful, obtaining the initial session information.

6. The permission management method as claimed in claim 5, wherein the step of conducting, by the initial cloud platform service which the calling party belongs to, the login check for the login authentication information, comprising:
sending, by the initial cloud platform service which the calling party belongs to, the login authentication information of the initial user to the account authentication system; and
conducting, by the account authentication system, the login check for the login authentication information of the initial use; if the login check is successful, establishing the initial session information of the initial user, and returning the initial session information to the initial cloud platform service which the calling party belongs to.

7. The permission management method as claimed in claim 1, wherein if the target cloud platform service determines that the session information doesn't include the initial session information of the calling party, or if the initial session information is invalid, the permission check comprises:
determining whether the session information is legitimate;
obtaining the permission information of the calling party according to the session information; and
determining whether the operation information and the target information of the operation/access request is legitimate according to the permission information of the calling party.

8. A permission management device for a cloud platform service, comprising:
an operation/access obtaining module configured to obtain an operation/access request of a calling party, wherein the operation/access request includes operation information, target information, and session information of the calling party, and the target information of the calling party includes this ongoing session information;
a session judgment module configured to determine that the session information includes an initial session information of the calling party and the initial session information is valid;
a permission check module configured to conduct an permission check for the operation/access request,
wherein if the session judgment module determines that the session information includes the initial session information of the calling party and the initial session information is valid, the permission check comprises:
determining whether the session information is legitimate;
obtaining permission information of the calling party and an initial user according to the ongoing session information and the initial session information, respectively;
determining whether the operation information of the operation/access request is legitimate according to the permission information of the calling party; and
determining whether the target information of the operation/access request is legitimate according to the permission information of the initial user.

9. The permission management device as claimed in claim 8, further comprising:
an indirect login obtaining module configured to obtain an indirect login request of the calling party, wherein the indirect login request includes login authentication information of the calling party and the initial session information;
an indirect login check module configured to conduct a login check for the login authentication information of the calling party and the initial session information, and if the login check is successful, obtain the session information of the calling party, the permission information of the calling party and the initial user; and
a login result returning module configured to return the session information to the calling party.

10. The permission management device as claimed in claim 9, wherein the indirect login check module comprises:
a login check request unit configured to send the log authentication information and the initial session information of the calling party to an account authentication system, so that the account authentication system conducts a login check for the login authentication information of the calling party and the initial session information, wherein if the login check is successful, the account authentication system will establish the session information of the calling party; and
a session information obtaining unit configured to obtain the session information of the calling party, the permission information of the calling party and the initial user from the account authentication system.

11. The permission management device as claimed in claim 10, the permission check module comprising:
a permission check request unit configured to send an indirect service authentication request to the account authentication system, wherein the indirect service authentication request includes the operation/access request and the session information of the calling party, so that the account authentication system conducts a permission check for the operation/access request and the session information of the calling party; and
a permission check obtaining unit configured to obtain the result of the permission check from the account authentication system.

12. The permission management device as claimed in claim 8, wherein if the session judgment module determines that the session information doesn't include the initial session information of the calling party, or if the initial session information is invalid, the permission check module conducting a permission check for the operation/access request comprises:
determining whether the session information is legitimate;
obtaining the permission information of the calling party according to the ongoing session information; and
determining whether the operation information and target information of the operation/access request is legitimate according to the permission information of the calling party.

13. A calling device for a cloud platform service, comprising:
an indirect operation request module configured to send an operation/access request to a target cloud platform service, wherein the operation/access request includes operation information, target information, and session information of a calling party, and the session information of the calling party includes an ongoing session information of the calling party and an initial session information, so that the target cloud platform service conducts a permission check for the operation/access request according to the session information of the calling party.

14. The calling device as claimed in claim 13, further comprising:
an indirect login request module configured to send an indirect login request to the target cloud platform service, wherein the indirect login request includes login authentication information of the calling party and the initial session information, so that the target cloud platform service conducts a login check for the login authentication information of the calling party and the initial session information; and
a login result obtaining module configured to obtain the session information of the calling party from the target cloud platform service after the login check of the target cloud platform service is successful.

15. The calling device as claimed in claim 13, further comprising:
a direct login obtaining module configured to obtain a direct login request of the initial user, wherein the direct login request includes login authentication information of the initial user; and
a direct login check module configured to conduct a login check for the login authentication information of the initial user, and if the login check is successful, obtain the initial session information of the initial user.

16. The calling device as claimed in claim 15, wherein the direct login check module comprises:
a login check request unit configured to send the login authentication information of the initial user to the account authentication system, so that the account authentication system checks the login authentication information of the initial user, if the login check is successful, the account authentication system establishes the initial session information of the initial user; and
an initial session obtaining unit configured to obtain the initial session information from the account authentication system after the login check for the login authentication information of the initial user conducted by the account authentication system is successful.

17. An account authentication system for a cloud platform service, comprising:
a permission check obtaining module configured to obtain an indirect service authentication request from a target cloud platform service, wherein the indirect service authentication request includes an operation/access request of a calling party and session information of the calling party, and the session information of the calling party includes an ongoing session information of the calling party and an initial session information;
an indirect service authentication module configured to conduct a permission check for the operation/access request of the calling party and the session information of the calling party; and
a permission check returning module configured to return a result of the permission check to the target cloud platform service,
wherein the permission check comprises:
determining whether the session information is legitimate;
obtaining permission information of the calling party and an initial user according to the ongoing session information and the initial session information, respectively;
determining whether the operation information of the operation/access request is legitimate according to the permission information of the calling party;
determining whether the target information of the operation/access request is legitimate according to the permission information of the initial user.

18. The account authentication system as claimed in claim 17, further comprising:
an indirect login check module configured to obtain login authentication information of the calling party and the initial session information from the target cloud platform service, conduct a login check for the login authentication information of the calling party and the initial session information, if the check is successful, establish the session information of the calling party;
a session information returning module configured to return the session information of the calling party to the target cloud platform service.

19. The account authentication system as claimed in claim 18, wherein the session information returning module is further configured to return the permission information of the calling party and the initial user to the target cloud platform service.

20. The account authentication system as claimed in claim 17, further comprising:
a direct login check module configured to obtain the login authentication information of the initial user of the calling party sent by the target cloud platform service which the calling party belongs to, conduct a login check for the login authentication information of the initial user, and if the login check is successful, establish the initial session information of the initial user;
an initial session returning module configured to send the initial session information to the target cloud platform service which the calling party belongs to.

21-22. (canceled)
